(19) United States
(12) Patent Application Publication
(10) Pub. No.: US 2025/0356268 A1
(43) Pub. Date: Nov. 20, 2025

(54) Secure Container Framework for Embedded AI Micro-Models with Lifecycle and Reasoning

(71) Applicant: Xinxin Shan, Surrey (CA)

(72) Inventor: Xinxin Shan, Surrey (CA)

(73) Assignee: LED Smart Inc, Surrey, BC (CA)

(21) Appl. No.: 19/279,744

(22) Filed: Jul. 24, 2025

(51) Int. Cl. G06N 20/20; G06F 9/52; G06F 11/07; H04L 9/32

(52) U.S. Cl. CPC G06N 20/20; G06F 9/52; G06F 11/0757; H04L 9/3247

(57) ABSTRACT

A secure container framework is disclosed for executing embedded AI micro-models in hardware-constrained or hybrid network environments. The system includes a secure execution container configured to manage AI micro-model lifecycle stages, enforce symbolic constraints, evaluate runtime telemetry, and optionally invoke fallback behaviors through alternate models or rule sequences. Each container includes cryptographically verifiable components such as policy maps, fallback subgraphs, and execution metadata. The invention supports mesh or non-mesh deployments, peer coordination, and operation on CPUs, GPUs, microcontrollers, or other equivalent or similar functionality hardware. The framework enables verifiable, autonomous, and policy-governed embedded AI operation.

### CROSS-REFERENCE TO RELATED APPLICATIONS

This application includes the Family Cross-Reference Statement as a part of CROSS-REFERENCE TO RELATED APPLICATIONS section.

This application is related to and claims priority benefit from the following co-pending applications:
application Ser. No. 19/210,386 filed on May 16, 2025
application Ser. No. 19/216,260 filed on May 22, 2025
application Ser. No. 19/242,792 filed on Jun. 18, 2025
application Ser. No. 19/247,262 filed on Jun. 24, 2025
application Ser. No. 19/249,405 filed on Jun. 25, 2025
application Ser. No. 19/258,413 filed on Jul. 2, 2025
application Ser. No. 19/260,383 filed on Jul. 4, 2025
application Ser. No. 19/274,276 filed on Jul. 18, 2025

These applications are part of a unified invention family focused on secure embedded AI execution, symbolic reasoning, lifecycle control, and mesh coordination of micro-models. All family patents are considered part of the same inventive family.

In addition, the following prior patents and technical disclosures are referenced for contextual comparison:

### US PATENT DOCUMENTS

US20250071069 A1 02/2025 Djuhera et al.
US20220121741 A1 04/2022 Araujo et al.
US20220114249 A1 04/2022 GRANCHAROV et al.
US20240236017 A1 07/2024 Guim Bernat et al.
U.S. Pat. No. 11,494,171 B1 11/2022 Acharya et al.
US20220050751 A1 02/2022 Hazra et al.
U.S. Pat. No. 11,694,061 B2 07/2023 Byrnes et al.

### BACKGROUND OF THE INVENTION

Artificial intelligence systems are increasingly required to operate in real-time environments with strict hardware limitations, such as microcontrollers, industrial sensors, edge gateways, and mobile platforms. Traditional AI frameworks—designed for large servers or cloud infrastructures—lack the ability to run efficiently, securely, and verifiably in embedded contexts.

Previous approaches to embedding AI on constrained platforms have focused on pruning or quantizing deep neural networks, often resulting in brittle or non-verifiable systems. While lightweight model compression and containerization have emerged, existing solutions fail to provide lifecycle enforcement, symbolic fallback control, or secure execution lineage in hybrid or offline networks.

Moreover, common container architectures rely on operating system primitives unavailable in low-power or firmware-only environments. This prevents reliable deployment, especially in safety-critical or governance-sensitive applications. Furthermore, fallback behavior is often undefined or purely reactive, lacking the symbolic interpretation needed to adapt behavior during uncertain conditions or partial failures.

To overcome these limitations, a secure, runtime-aware container framework is needed—capable of enforcing policy constraints, verifying execution integrity, and triggering symbolic fallback reasoning within an embedded AI micro-model. This invention fills that gap by introducing a self-contained, hardware-independent execution framework built explicitly for AI micro-models.

### SUMMARY OF THE INVENTION

The invention provides a secure container execution framework designed to host embedded AI micro-models in constrained or hybrid environments. It includes a compact execution container with optional symbolic reasoning modules, fallback handling, lifecycle governance, and cryptographically verifiable payload segments.

Unlike prior solutions, the framework is optionally configured to operate on a hardware-independent platform, such as a CPU, GPU, FPGA, ASIC, or other equivalent or similar functionality microprocessor, without requiring full operating system support. The container system manages initialization, bootstrapping, signature verification, runtime policy application, telemetry-driven monitoring, and symbolic fallback triggering.

At runtime, the container optionally activates symbolic policy evaluation modules that govern acceptable input-output behavior. These may include rules regarding sensor signal range, execution delay bounds, or inter-model message validity. The container also optionally supports fallback behavior—including invocation of alternate models, rule-based symbolic logic, or predefined recovery actions—triggered by telemetry evaluation or symbolic constraint breaches.

Each container is optionally configured to operate in mesh or non-mesh configurations and can communicate with peer containers or a secure gateway. The container payload is segmented into independently verifiable units including: symbolic policy maps, encrypted model logic, telemetry schemas, fallback subgraphs, and execution metadata. These segments are sealed with cryptographic identifiers to ensure trusted execution.

Additionally, the invention introduces peer-synchronized symbolic fallback handling across distributed containers, enabling real-time coordination under constrained or partially disconnected networks. The container system thus enables robust, policy-compliant embedded AI execution—whether operating autonomously or within a larger network of AI-enabled devices.

### BRIEF DESCRIPTION OF DRAWINGS

FIG. 1 illustrates a high-level block diagram of the secure container execution environment for embedded AI micro-models. It includes components such as the execution container, micro-model core, runtime policy manager, telemetry handler, fallback module, and hardware platform.

FIG. 2 shows the lifecycle stages of the AI micro-model within the secure container, including signature verification, model bootstrapping, activation, runtime monitoring, fallback triggering, and secure shutdown.

FIG. 3 depicts a symbolic fallback architecture in which a decision engine selects between fallback micro-models, symbolic rule sequences, and predefined safe behaviors. It also includes peer communication for distributed fallback logic.

FIG. 4 presents examples of hardware-independent deployment of the secure container, showing compatibility with microcontrollers, GPUs, CPUs, and equivalent or similar functionality hardware via interface adapters.

FIG. 5 illustrates the deployment of containerized AI micro-models in both network and non-network environments, including isolated operation and coordinated execution via mesh gateways.

FIG. 6 shows the internal segmentation of the encrypted container payload, including symbolic policy map, encrypted model logic, fallback subgraph, telemetry schema, and metadata manifest.

FIG. 7 demonstrates secure coordination between multiple containers via a gateway that processes telemetry, verifies symbolic policy compliance, and issues constraint updates or execution synchronization.

### DETAILED DESCRIPTION OF THE INVENTION

Referring initially to FIG. 1, the invention introduces a secure execution container (101) designed to encapsulate and manage the execution of embedded AI micro-models. Within the container (101), the AI micro-model core (102) operates as the central decision-making unit, optionally pre-trained and bounded in resource use. A runtime policy manager (103) governs behavior through symbolic or numeric constraints. Telemetry handler (104) collects internal and environmental data for evaluation, and an optional fallback module (105) provides recovery logic under abnormal or policy-violating conditions. The container is deployed to an embedded platform (106), which may include a microcontroller, CPU, GPU, FPGA, ASIC, or other equivalent or similar functionality hardware. A container orchestrator (107) manages the container's lifecycle transitions, and a container signature verifier (108) ensures that the container and its payload are authentic and untampered.

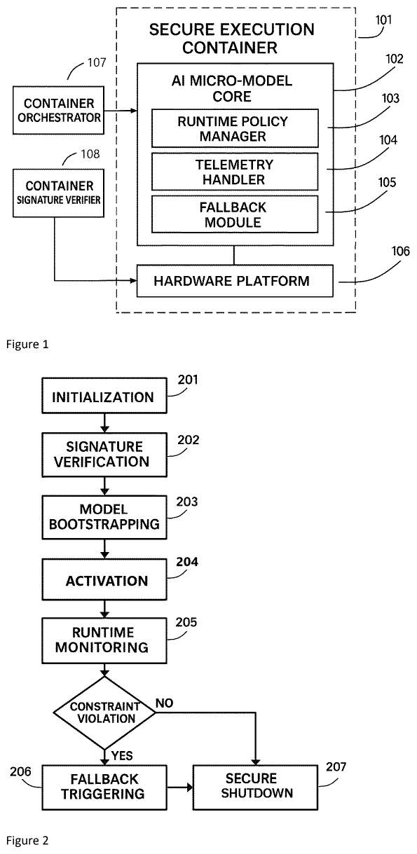

Turning to FIG. 2, the container lifecycle begins with initialization (201), followed by digital signature verification (202) using container-bound or platform-bound keys. Upon successful verification, the container proceeds with bootstrapping the AI micro-model (203), which includes loading memory-mapped components and resolving policy and telemetry references. Once activated (204), the model operates in a constrained environment with continuous runtime monitoring (205). If symbolic or telemetry-based policy violations are detected, fallback triggering (206) is initiated. The container may then enter secure shutdown (207) based on execution state, policy outcome, or external control.

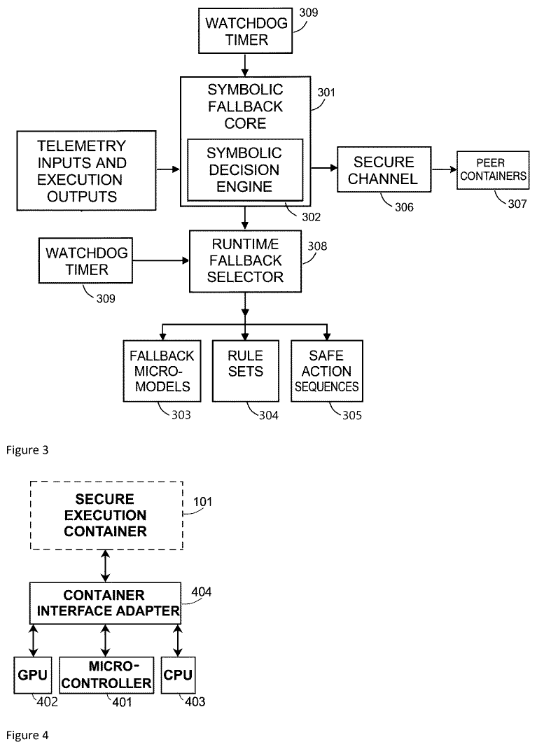

Referring to FIG. 3, a symbolic fallback execution architecture is illustrated. The fallback logic begins with a runtime monitor (301) that detects anomalous or uncertain behaviors based on telemetry inputs and execution outputs. A symbolic decision engine (302) interprets the incoming telemetry and model status through a predefined policy map. When a fallback condition is triggered, the system invokes a fallback micro-model (303), a symbolic rule path (304), or a safe behavior actuator (305) depending on the nature of the violation. These are selected dynamically by a runtime fallback selector (306) that integrates constraints from the symbolic policy space. Peer containers (307) are also engaged via distributed coordination protocols to validate or reinforce fallback outcomes in cooperative mesh environments. A Watchdog Timer (308) is included to enforce fail-safe recovery if the symbolic execution or telemetry feedback fails to return within a specified interval. This component ensures bounded operation and fallback escalation. This layered approach ensures that fallback decisions are both interpretable and robust across deployment contexts.

FIG. 4 demonstrates deployment across heterogeneous hardware. The secure container (101) is instantiated on platforms ranging from minimal IoT chips (401) to GPU compute units (402) and CPU cores (403). A container interface adapter (404) abstracts the underlying hardware features, allowing hardware-independent execution through standardized memory, I/O, and clock interfaces.

FIG. 5 illustrates the deployment of containerized AI micro-models in both networked and isolated environments. In the networked deployment case (501), the secure containers communicate over a mesh gateway (503), exchanging policy updates, execution telemetry, and fallback signals. These communications are conducted using multiple supported protocols such as Wi-Fi, Bluetooth Mesh, Thread, Zigbee, Ethernet, or CAN Bus, selected dynamically through protocol negotiation logic. In the isolated deployment case (502), containers operate autonomously, applying locally cached symbolic policy maps and executing fallback decisions without requiring network access. The gateway (503) can manage and coordinate fallback orchestration in connected topologies, while each container remains independently secure and symbolically constrained in disconnected operation. This design enables wide deployment in both infrastructure-rich and air-gapped environments.

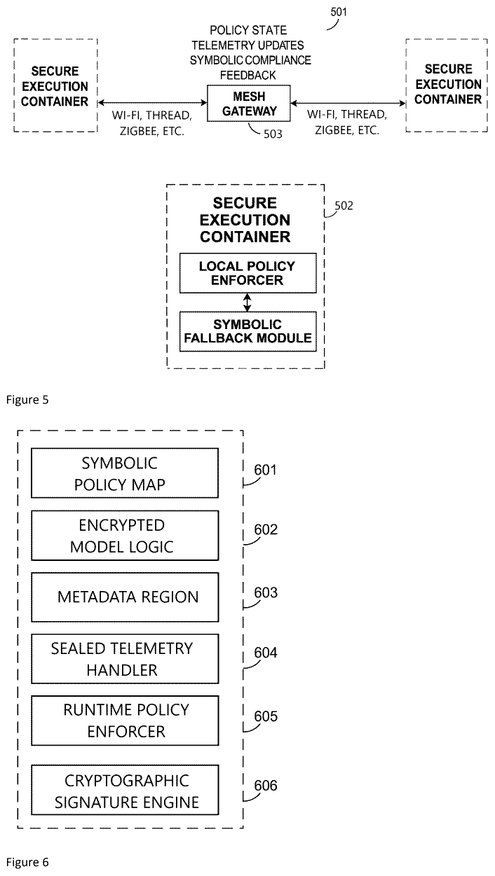

FIG. 6 shows the internal structure of an encrypted execution container payload. The container comprises several segmented regions, each cryptographically protected and governed by embedded symbolic constraints. The symbolic policy map (601) defines rules for runtime decisions and model behavior. The encrypted AI logic segment (602) contains the distilled micro-model execution graph. The metadata region (603) stores runtime attributes such as version, origin, and authorized behaviors. A sealed telemetry handler (604) is included to capture and forward execution traces. Each container also includes a runtime policy enforcer (605) that interprets and applies symbolic constraints dynamically. Each segment is cryptographically signed by a Cryptographic Signature Engine (606), which applies a container-specific sealing key to verify integrity and version provenance. The structural boundaries of each segment are verified on load, ensuring the container is tamper-evident and self-consistent.

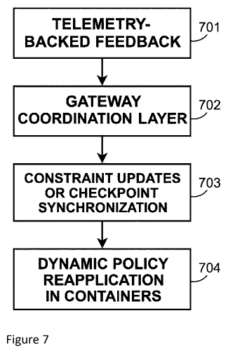

FIG. 7 illustrates the symbolic coordination feedback loop between execution containers and mesh gateways. The telemetry engine (701) collects runtime outputs and decision paths. These telemetry streams are transmitted to a coordination gateway (702), which applies symbolic constraint overlays (703) using distributed policy updates. These are then re-applied to the execution container (704) to update operational behavior, forming a closed symbolic feedback loop. This process allows the container to adaptively respond to environmental changes, peer inputs, or symbolic exceptions while preserving security and traceability. Arrows between 701→702→703→704 are emphasized in the diagram to illustrate the full telemetry and policy reinforcement cycle.

The invention enables secure, symbolic, and verifiable deployment of AI micro-models to embedded platforms without reliance on full operating systems. It optionally supports operation in mesh or non-mesh configurations, with or without network access. The symbolic fallback framework adds robustness by enabling the system to interpret ambiguous, failed, or policy-violating states and recover through predefined logical paths.

The container is optionally configured to log execution lineage in a cryptographically verifiable audit chain. Such logs may include model activations, fallback decisions, telemetry thresholds, and symbolic transitions. This enables full lifecycle traceability for safety-critical applications such as industrial automation, sensor networks, and edge inference gateways.

Additionally, the symbolic fallback logic supports blending—where the decision engine evaluates policy violations using fuzzy or threshold-based metrics instead of binary rule failures. This capability allows the system to operate under uncertainty and adjust behavior gracefully. Peer communication over secure channels supports distributed execution, synchronization of state, and consensus-based policy realignment.

This framework addresses long-standing challenges in embedded AI systems: deterministic control, symbolic reasoning, secure lifecycle enforcement, hardware abstraction, and fallback resilience.

### AI MICRO-MODEL FOUNDATIONAL DEFINITION

As used in this application, an AI micro-model refers to a self-contained, compact, and optionally pre-trained computational unit that performs autonomous or semi-autonomous reasoning, sensing, or control within an embedded environment. It is characterized by bounded resource usage, localized input-output logic, and optional symbolic or data-driven policies. AI micro-models may be hardware-agnostic and capable of secure, verifiable, and fallback execution.

### LEGAL PROTECTION AND ANTI-CIRCUMVENTION STATEMENT

Any attempt to replicate, circumvent, or substitute any aspect of the invention, including symbolic logic rules, embedded model packaging, fallback coordination, or container orchestration mechanisms, whether by software or hardware means, falls within the scope of this disclosure and is protected accordingly. Equivalent or similar implementations are considered part of this invention under the doctrine of equivalents.

1. A secure container system for embedded AI micro-model execution, comprising:
a secure execution container deployed on a hardware-independent platform, the container being configured to verify, activate, and manage an embedded AI micro-model;
a runtime policy manager within the container, the manager being optionally configured to enforce at least one symbolic constraint governing model behavior;
a telemetry handler configured to receive model state information and evaluate it against said symbolic constraint; and
a fallback module optionally configured to execute alternative or mixing behaviors, wherein the fallback behaviors include execution of a secondary AI micro-model, a symbolic rule sequence, or a predefined recovery routine,
wherein the system is configured to operate in mesh or non-mesh networks, and
wherein each container payload includes cryptographically signed segments representing at least one of: a symbolic policy map, encrypted model logic, fallback subgraph, telemetry schema, or metadata manifest.

2. The system of claim 1, wherein the container is optionally configured to execute multiple AI micro-models in parallel and switch between them based on telemetry evaluation.

3. The system of claim 1, wherein the fallback module includes at least one symbolic decision engine configured to evaluate rule-based conditions.

4. The system of claim 1, wherein the telemetry handler records operational state to a tamper-evident log.

5. The system of claim 1, wherein the secure container is deployable on a microcontroller, edge AI chip, or other equivalent or similar functionality embedded processor.

6. The system of claim 1, wherein the metadata manifest includes at least one hardware compatibility flag and deployment constraint indicator.

7. The system of claim 1, wherein the secure container enforces deterministic execution order by using runtime synchronization points.

8. The system of claim 1, wherein the secure execution container is optionally configured to log execution lineage and transfer it to a remote audit node.

9. A method of lifecycle-controlled execution of an embedded AI micro-model on a hardware-independent platform, comprising:
initializing a secure container on a processing platform comprising at least one of a CPU, GPU, FPGA, ASIC, or other equivalent or similar functionality device;
verifying the digital signature of an AI micro-model payload within said container;
activating said AI micro-model and applying a symbolic or numerical constraint policy via a runtime policy engine;
receiving telemetry data during execution and evaluating it against said constraint policy; and
optionally triggering a fallback execution path based on the evaluation outcome,
wherein the fallback path comprises symbolic reasoning, peer coordination, or alternate model invocation,
and wherein the system maintains verifiability and auditability through cryptographically secured logs and state transitions.

10. The method of claim 9, wherein the symbolic constraint policy includes at least one condition based on input feature range, output class confidence, or execution duration.

11. The method of claim 9, wherein fallback triggering includes peer signaling between containers in a distributed mesh network.

12. The method of claim 9, wherein telemetry evaluations occur continuously and drive real-time constraint reapplication.

13. The method of claim 9, wherein digital signature verification is performed using container-bound hardware keys.

14. The method of claim 9, wherein fallback includes segmentation of model execution into symbolic subgraphs triggered conditionally.

15. An embedded execution framework for AI micro-models comprising:
a plurality of secure containers, each containing at least one AI micro-model, a runtime policy module, and a telemetry handler;
a gateway coordination module configured to receive telemetry feedback from each container and determine updated execution constraints;
a symbolic policy engine within each container configured to evaluate and apply updated constraints to ongoing execution; and
a coordination interface configured to support secure communication among said containers for distributed fallback activation,
wherein said containers operate in network or non-network environments,
and wherein each container is optionally configured to operate in isolated mode with locally governed lifecycle and fallback control.

16. The framework of claim 15, wherein the gateway coordination module supports both centralized and peer-to-peer execution models.

17. The framework of claim 15, wherein the symbolic policy engine operates as a hybrid model combining logic tree evaluation with neural response interpretation.

18. The framework of claim 15, wherein the coordination interface supports encrypted transport over Bluetooth Mesh, Thread, Wi-Fi, or PLC protocols.

19. The framework of claim 15, wherein the containers include optional watchdog timers to enforce recovery or shutdown on execution stalls.

20. The framework of claim 15, wherein fallback decisions include at least one peer-verified symbolic rule evaluation.
